(19) United States
(12) Patent Application Publication
(10) Pub. No.: US 2011/0231477 A1
(43) Pub. Date: Sep. 22, 2011

(54) SYSTEM AND METHOD TO SERVICE REQUESTS FROM A PLURALITY OF SOURCES

(76) Inventors: Ido Safruti, San Francisco, CA (US); Ronni Zehavi, Sunnyvale, CA (US); David Drai, Kfar Yona (IL); Udi Trugman, Alfe-Menashe (IL)

(21) Appl. No.: 12/729,146

(22) Filed: Mar. 22, 2010

(51) Int. Cl. G06F 15/16

(52) U.S. Cl. 709/203

(57) ABSTRACT

A method and system for processing a request for service from a user application is disclosed. The request for service from a user application is received. The request for service is directed to a server application. A plurality of servers are provided to service the request. A server to service the request from amongst the plurality of servers is selected. The request is sent to the selected server. A response from the selected server is received. The received response is forwarded to the user application.

### CROSS-REFERENCE TO RELATED APPLICATIONS

NONE

### TECHNICAL FIELD

The present invention relates generally to servicing requests from a user application using networked computer sources and particularly, to servicing requests from a plurality of redundant sources.

### BACKGROUND

The Internet has enabled computer users all over the world to interact, communicate and access information electronically. One particularly popular mode for communication is to send requests over the internet by a user or a user application using a user system coupled to the internet and the user system receives responses to the requests over the internet from a server also coupled to the internet.

As more and more user systems communicate with servers coupled over the internet, there is a need to find efficient ways to service the user requests. With these needs in mind, the current disclosure arises. This brief summary has been provided so that the nature of the disclosure may be understood quickly. A more complete understanding of the disclosure can be obtained by reference to the following detailed description of the various embodiments thereof in connection with the attached drawings.

### SUMMARY OF THE INVENTION

In one embodiment, a method for processing a request for service from a user application is disclosed. The request for service from a user application is received. The request for service is directed to a server application. A plurality of servers are provided to service the request. A server to service the request from amongst the plurality of servers and the source server is selected. The request is sent to the selected server. A response from the selected server is received. The received response is forwarded to the user application.

In yet another embodiment, a system for processing a request for service from a user computer to a server application is disclosed. The system includes a delivery server. The delivery server is configured to receive the request for service from a user application executed on the user computer. The request for service is directed to the server application. The delivery server selects a server to service the request. The delivery server sends the request to the selected server. The delivery server receives a response from the selected resource. The delivery server forwards the modified response to the user application.

In yet another embodiment, a system for processing requests from at least two user computers to a server application is disclosed. The system includes a first delivery server and a second delivery server. The first delivery server is configured to receive the request for service from the user application executed on the first user computer. The request for service is directed to the server application. The first delivery server selects a server from amongst a first set of plurality of servers to service the request, sends the request to the selected server, and receives a response from the selected server. The first delivery server forwards the response to the user application of the first computer. The second delivery server configured to receive the request for service from the user application executed on the second user computer. The request for service is directed to the server application. The first delivery server selects a server from amongst a second set of plurality of servers to service the request, sends the request to the selected server, and receives a response from the selected server. The second delivery server forwards the response to the user application of the second computer. The first set of plurality of servers are different than the second set of plurality of servers.

This brief summary has been provided so that the nature of the disclosure may be understood quickly. A more complete understanding of the disclosure can be obtained by reference to the following detailed description of the preferred embodiments thereof in connection with the attached drawings.

### BRIEF DESCRIPTION OF THE DRAWINGS

The foregoing and other features of several embodiments are now described with reference to the drawings. In the drawings, the same components have the same reference numerals. The illustrated embodiments are intended to illustrate but not limit the invention. The drawings include the following Figures:

FIG. 1A shows a block diagram of a system used to service requests from a user system, according to one aspect of the present disclosure;

FIG. 1B shows a block diagram of a user system configured to communicate with a server over the network, according to one aspect of the present disclosure;

FIG. 2 shows a block diagram of the internal functional architecture of a user computer, according to one aspect of the present disclosure;

FIG. 2A shows a block diagram of another embodiment of a system used to service requests from a user computer, according to another aspect of the present disclosure;

FIG. 3 shows an exemplary topology of computer network coupling user computers to servers over the internet, according to one aspect of the present disclosure;

FIG. 4 shows another exemplary topology of computer network coupling user computers to servers over the interne, with a delivery server and a management server, according to one aspect of the present disclosure;

FIGS. 5A and 5B shows various functional block diagrams of the delivery server and management server of FIG. 4, according to one aspect of the present invention;

FIG. 5C shows exemplary configuration table in a delivery server for a server application;

FIG. 5D shows exemplary configuration table in another delivery server for the server application of FIG. 5C;

FIG. 6 shows method of processing a request from a user computer, according to one aspect of the present disclosure;

FIG. 7 shows method of processing another request from the user computer, according to one aspect of the present disclosure.

### DETAILED DESCRIPTION

To facilitate an understanding of the adaptive aspects of the present invention, the general architecture and operation of a networked system is described. The specific architecture and operation of the adaptive aspects of the present disclosure are then described with reference to the general architecture.

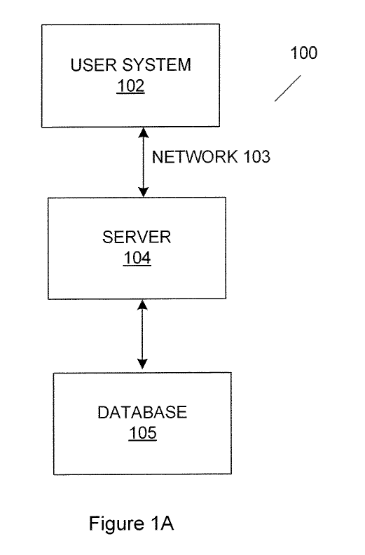

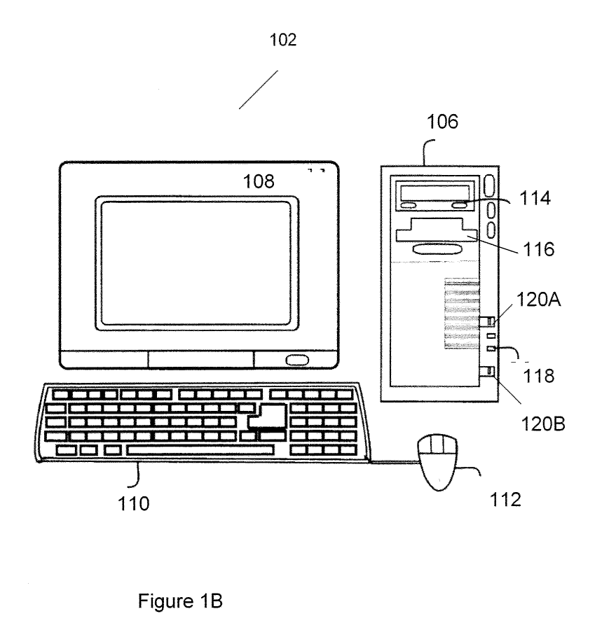

FIG. 1A shows a top-level block diagram of a system 100 that is used to service requests from a user system, according to one aspect of the present disclosure. System 100 includes a user system 102 that is coupled via a network connection 103 to a server 104. In one aspect, server 104 is a web-server. Database 105 is used to store information that is accessed by the user system 102. In one aspect, database 105 is a structured query language (SQL) based database.

FIG. 1B is a block diagram of a user system 102 according to one embodiment of the present disclosure, which is configured to communicate with a server over the network. FIG. 1B includes a user computer 106 (sometimes referred to as computer 106) and a monitor 108. Monitor 108 may be a CRT type, a LCD type, a plasma type, or any other type of color or monochrome display. Also provided with computer 106 is a keyboard 110 for entering text data and user commands, and a pointing device 112 (such as a mouse) for processing objects displayed on monitor 108. In some embodiments, objects displayed on monitor 108 may be elements of a graphical user interface.

Computer 106 may include a computer-readable memory medium such as a rotating disk 114 for storing readable data. Besides other programs, disk 114 can store application programs including web browsers by which computer 106 connects to a network and the systems described below, according to one aspect of the present disclosure. In some embodiments, disk 114 may be a disk system with a plurality of disk drives arranged as a Redundant Array of Inexpensive Drives (RAID) system, accessible using a storage adapter (not shown).

Computer 106 can also access a computer-readable storage device 116 with removable storage media storing data files, application program files, and computer executable process steps embodying the present invention or the like. For example, the storage device 116 may be a CD-ROM or a DVD ROM. In some embodiments, the storage device 116 may support removable storage media that is read-only device (R), write once-read many (WORM), or rewriteable (RW) type. In some embodiments, the storage device 116 may also be provided with computer 106 to access application program files, audio files and data files stored on a removable storage media. In some embodiments, the removable storage media may be optical, magnetic, magneto-optic, or semiconductor based recording media.

A modem, an integrated services digital network (ISDN) connection, wireless or the like also provides computer 106 with a DSL/Cable/satellite/wireless (or Internet connection) 118 to the World Wide Web (WWW). Internet connection 118 allows computer 106 to send and receive commands, data files, audio files, application program files and computer-executable process steps embodying the present invention.

Computer 106 is also provided with external audio speakers 120A and 120B to assist a listener to listen to music either downloaded on-line from the Internet or off-line using a storage medium. It is noteworthy that a listener may use headphones instead of audio speakers 120A and 120B to listen to music.

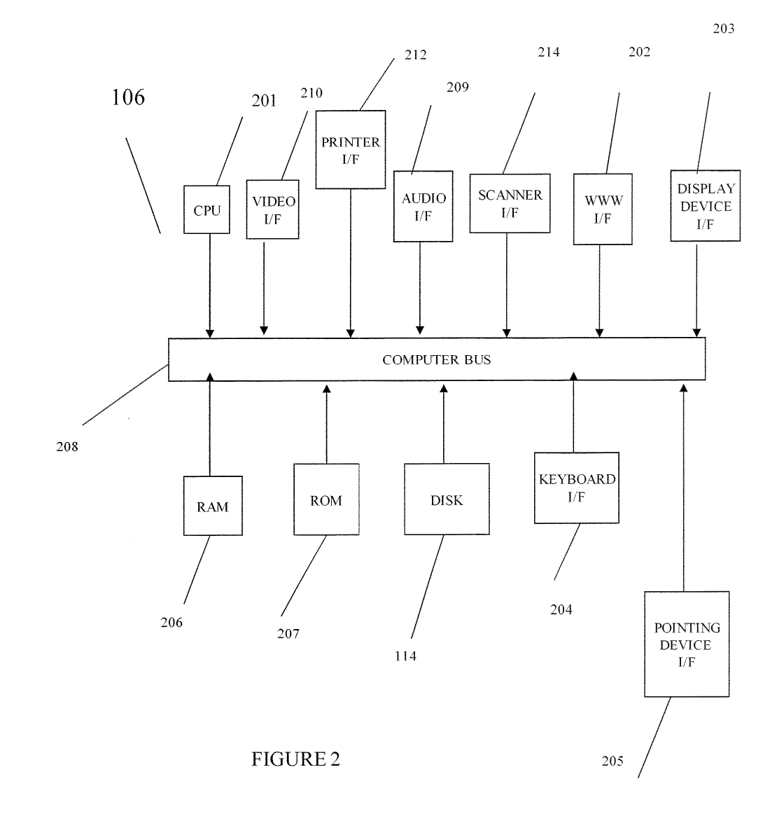

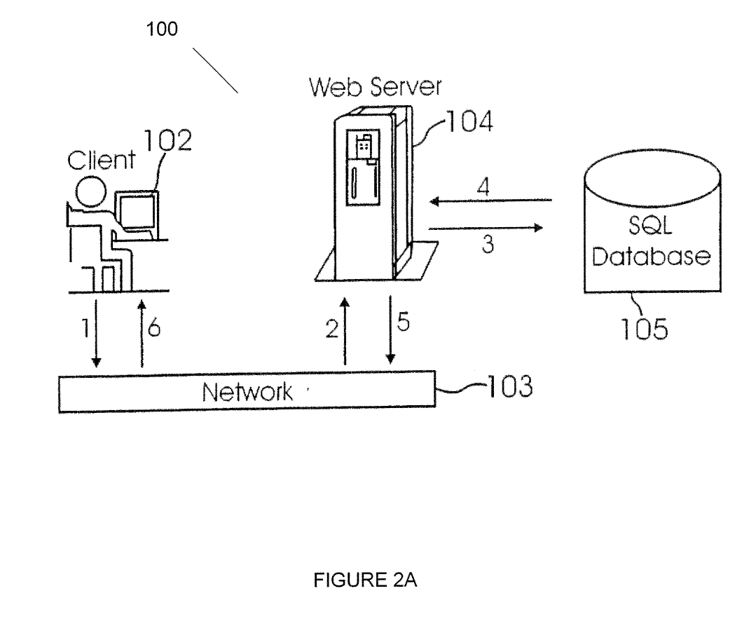

FIG. 2 is a block diagram showing the internal functional architecture of computer 106. As shown in FIG. 2, computer 106 includes a central processing unit (CPU) 201 for executing computer-executable process steps and interfaces with a computer bus 208. Also shown in FIG. 2 area WWW interface 202, a display device interface 203, a keyboard interface 204, a pointing device interface 205, an audio interface 209, video interface 210, printer interface 212, and a disk 114. Audio Interface 209 allows a listener to listen to music, Online (downloaded using the Internet or a private network) or offline (using a CD).

As described above, disk 114 may store operating system program files, application program files, web browsers, and other files. Some of these files are stored on disk 114 using an installation program. For example, CPU 201 executes computer-executable process steps of an installation program so that CPU 201 can properly execute the application program.

A random access main memory (“RAM”) 206 also interfaces to computer bus 208 to provide CPU 201 with access to memory storage. When executing stored computer-executable process steps from disk 114 (or other storage device such as storage device 116 or Internet connection 118), CPU 201 stores and executes the process steps out of RAM 206.

Read only memory (“ROM”) 207 is provided to store invariant instruction sequences such as start-up instruction sequences or basic input/output operating system (BIOS) sequences for operation of keyboard 110.

FIG. 2A shows yet another example of the overall system 100, according to one aspect of the present disclosure. In FIG. 2A, server 104 is shown as a web server and database 105 is shown as a SQL (structured query language) database. FIG. 2A also shows the various steps that are used to access database 105. In step 1, a user using a browser running on the user system 102, submits a URL, as a request. URL includes the application to which the request is directed. In step 2, the web server 104 captures the request, and locates and executes corresponding application specific program (ASP) code for the application to which the request was directed.

In step 3, during execution of ASP code, a structured query language (SQL) code is generated and executed. Based on the executed SQL code, database 105 is accessed to fetch, add, modify or delete information in the database.

In step 4, the results are sent to the web server 104. The web server 104 constructs a response, for example as a HTML code. In step 5, HTML code is sent to the user system 102. In step 6, the HTML page is sent to the browser and displayed on the user system 102.

Although in this example, a user submits a URL as a request, in some embodiments, a user application executing on the user computer 102 may submit a request. The request may be submitted as a URL, and the user application may be configured to receive the response to the request.

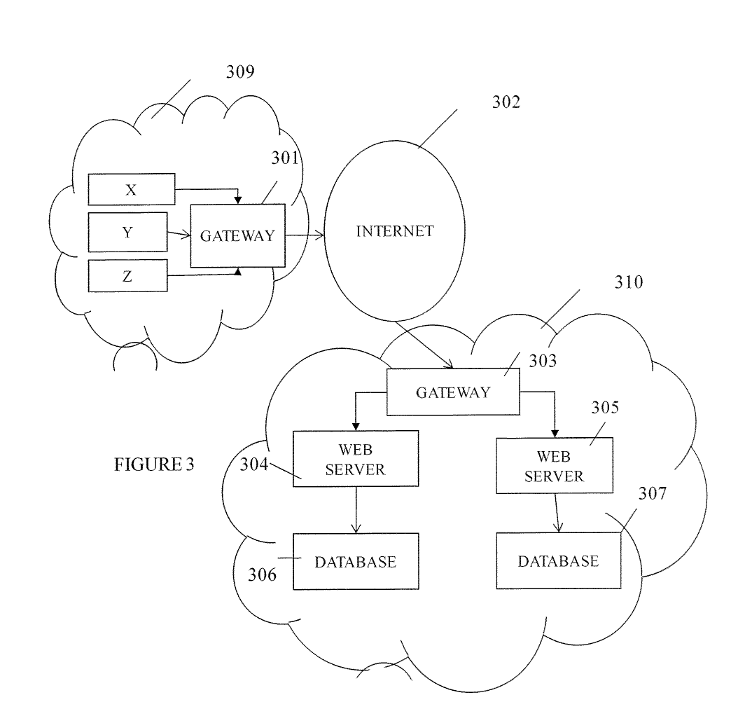

Now, an exemplary coupling of the computer 106 to a server over the internet will be described with reference to FIG. 3. FIG. 3 shows an exemplary topology of a computer network with computers similar to computer 106, connected to the Internet 302. For illustration purposes, three computers X, Y and Z are shown connected to the Internet 302 via Web interface 202 through a gateway 301, where gateway 301 can interface N number of computers. Web interface 202 may be a modem, network interface card or a unit for providing connectivity to other computer systems over a network using protocols such as X.25, Ethernet or TCP/IP, or any device that allows, directly or indirectly, computer-to-computer communications. For convenience, gateway 301 and computers X, Y and Z are grouped together and referred to as user cloud 309. Exemplary topology of a computer network may have additional groups of computers with gateway to define additional user clouds.

It is noteworthy that the invention is not limited to a particular number of computers. Any number of computers can be connected to the Internet 302 or any other computer network may be used.

FIG. 3 further shows a second gateway 303 that connects a network of web servers 304 and 305 to the Internet 302. Web servers 304 and 305 may be connected with each other over a computer network. Web servers 304 and 305 receive requests from the user computer and respond to the requests received from the user computer. Web server 304 is coupled to a database 306 and web server 305 is coupled to a database 307. For example, the user computer 106 may request a content stored on the database 306, for example, music samples, audio clips, data files etc. Web server 304 receives the request from the user computer 10 and responds to the request, by retrieving the content from the database 306. For convenience, gateway 303, servers 304 and 305, and databases 306 and 307 are grouped together and referred to as source cloud 310. Exemplary topology of a computer network may have additional groups of servers with gateways and databases to define additional source clouds.

The following provides a brief description of the Internet. The Interne connects thousands of computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language (“XML”) as published by W3C Consortium, Version 1, Second Edition, October 2000, ©CW3C may also be used. The collection of all such publicly available computer files is known as the World Wide Web (WWW). The WWW is a multimedia-enabled hypertext system used for navigating the Internet and is made up of hundreds of thousands of web pages with images and text and video files, which can be displayed on a computer monitor. Each web page can have connections to other pages, which may be located on any computer connected to the Internet.

Atypical Internet user uses a client program called a “Web Browser” to connect to the Internet. A web browser is a software program that allows users to access the content stored in Web sites. Modern Web browsers can also create content “on the fly”, according to instructions received from a Web site. This concept is commonly referred to as “dynamic page generation”. In addition, browsers can commonly send information back to the Web site, thus enabling two-way communication of the user and the Web site. A user can connect to the Internet via a proprietary network, such as America Online, or via an Internet Service Provider, e.g., Earthlink. The web browser may run on any computer connected to the Internet. Currently, various browsers are available of which two prominent browsers are Microsoft Internet Explorer and Mozilla Firefox. The Web Browser receives and sends requests to a web server and acquires information from the WWW. A web server is a program that, upon receipt of a request, sends the requested data to the requesting user. A standard naming convention known as Uniform Resource Locator (“URL”) has been adopted to represent hypermedia links and links to network services. Most files or services can be represented with a URL.

URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is Hypertext Transfer Protocol (HTTP).

Web domain is an Internet address that provides connection to a Web server. Generally, URLs have three parts: the first part describes the protocol used to access the content pointed to by the URL, the second contains the directory in which the content is located, and the third contains the file that stores the content: <protocol>:<domain><directory><file>.

For example:
http://www.cotendo.com/bios.html
http://www.cotendo.com/index.html
http://fn.cnn.com/archives/may2009/pr3.html
ftp://user1.cotendo.com/software/pages.zip

Commonly, the <protocol> part may be missing. In that case, modern Web browsers access the URL as if the http://prefix was used. In addition, the <file> part may be missing. In that case, one of the convention calls for the file “index.html” to be fetched. In some cases, the request may be redirected to fetch another default file.

For example, the following are legal variations of the previous example URLs:

www.cotendo.com/bios.html
www.cotendo.com
fn.cnn.com/archives/may2009/pr3.html
ftp://user1.cotendo.com/software/pages.zip Web Page.

Web page is the content associated with a URL. In its simplest form, this content is static text, which is stored into a text file indicated by the URL. However, very often, the content contains multi-media elements (e.g. images, audio, video, etc) as well as non-static text or other elements (e.g. news tickers, frames, scripts, streaming graphics, etc). Very often, more than one file forms a Web page. However, there is only one file that is associated with the URL and which initiates or guides the Web page generation.

When a Web browser receives an URL, the Web browser requests a Domain Name System (DNS) name server to decode the domain name and return the IP address for the domain name. The DNS name server returns the IP address of the domain name as stored in the DNS name server to the web browser. Web browser uses the IP address for the domain name and sends a request corresponding to the requested URL that confirms to the HTTP protocol to the IP address. In one embodiment, the request is sent using TCP/IP protocol over the internet.

In one embodiment, the user computer 106 sends requests to the server using HTTP protocol. As previously described with reference to FIG. 2A, the request is processed by the web server and a response is sent to the user computer. In the exemplary topology described with reference to FIG. 3, the request is sent over the internet to the server.

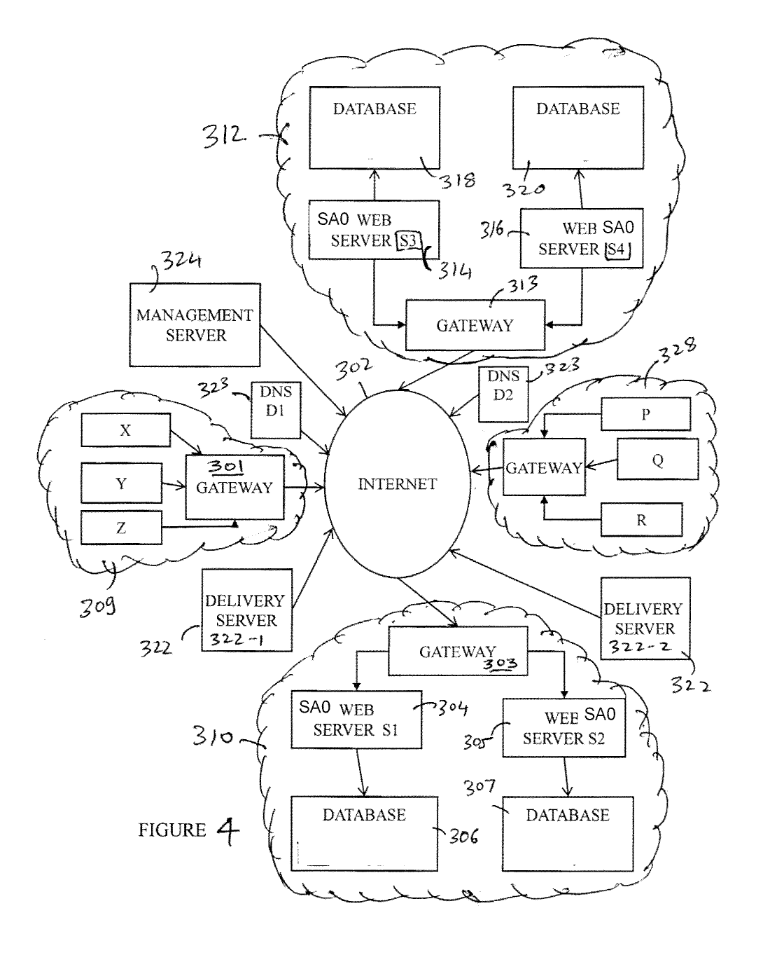

Now, referring to FIG. 4, another exemplary topology of a computer network for use with this disclosure is described. In this exemplary topology, there is an additional exemplary user cloud 328. User cloud 328 may be similar to user cloud 309. For example, user cloud 328 includes a gateway and a plurality of computers P, Q and R connected to the gateway. The computers P, Q and R may be similar to user computer 106.

In this exemplary topology, in addition to the source cloud 310, there is a mirror cloud 312 coupled to the internet. Mirror cloud 312 in one example, includes web server 314 and web server 316 coupled to a gateway 313. The gateway 313 is coupled to the internet 302. Web server 314 is coupled to a database 318. Web server 316 is coupled to a database 320.

In some embodiments, the mirror cloud 312 may be a partial or complete replica of the source cloud 310. As an example, the mirror cloud 312 may be a complete replica of the source cloud 310, if all of the contents of database 306 and 307 are available on database 318 and database 320 respectively. For example, any request that may be serviced by server 304 of source cloud 310 using database 306 can be serviced by server 314 of mirror cloud 312 using database 318.

As another example, mirror cloud 312 may be a partial replica of the source cloud 310, wherein only contents of database 306 are available on database 318. In such a scenario, any request that may be serviced by server 304 using database 306 may be serviced by server 314 using database 318.

Although in this description, contents of a database are used as an example, as one skilled in the art appreciates, alternate configurations of mirror clouds may be set up to service different types of requests using the mirror clouds based upon type of application requesting the service, type of data being requested and the likes. As another example, only portions of the content of database 306 may be available on database 318.

As yet another example, only some applications that are available on a server may be available on one or more of additional servers. As an example, server application SA0 is available on server 304. Server application SA0 may also be available on server 305, server 14 and server 316. Although only one server application SA0 is described, other server applications may be available on one or more servers. For convenience, server 304 is sometimes referred to as server S1. Similarly, servers 305, 314 and 316 are referred to as servers S2, S3 and S4 respectively.

In some embodiments, server application may be indicated in a URL as a domain, for example hosting of www.cotendo.com. In some embodiments, the server application may be indicated in a URL as a host, for example, ido.blogspot.com. In some embodiments, the server application may be indicated in a URL as a directory, for example, www.google.com/mail/. As one skilled in the art appreciates, server applications may be a hosted customer relationship management software (CRM) application, a website, online shop, news service, search applications, social networking applications, blog sites, webmail and the like.

According to an embodiment of this disclosure, the network topology of FIG. 4 further includes one or more delivery servers 322 coupled to the internet 302. Additionally, a management server 324 is coupled to the internet 302. In one embodiment, the delivery server 322 is configured so as to receive the requests from the user computer of a given user cloud. For example, delivery server 322-1 may be configured to receive user requests from user cloud 309. The management server 324 configures the delivery server 322 to process the user requests. The delivery server 322 processes the user request and directs the user request to the source cloud 310 or one of the minor clouds 312. More specifically, the user request is directed to a specific application, say application SA0. The Delivery server 322 selects one of the servers configured to service requests for application SA0 and sends the request to the selected server. In this example, the delivery server 22 may be able to send the request to server 304 or server 314. Selection of the server will be later described in greater detail.

In one embodiment, the delivery servers 322 are configured to receive requests from a given user cloud. As an example, delivery server 322-1 may be configured to receive requests from the user cloud 309. And, delivery server 322-2 may be configured to receive requests from user cloud 328. As previously described, the decoding of the address for the domain name is done by a DNS name server. According to an embodiment of this disclosure, the DNS name servers are configured so as to return the IP address of the preferred delivery server 322 as the address for the domain name specified in the user request. In one embodiment, the management server 324 configures DNS name servers so that a specific delivery server 322 is selected for a user request.

Configuration of the DNS name server and selection of a specific delivery server 322 will be later described in greater detail.

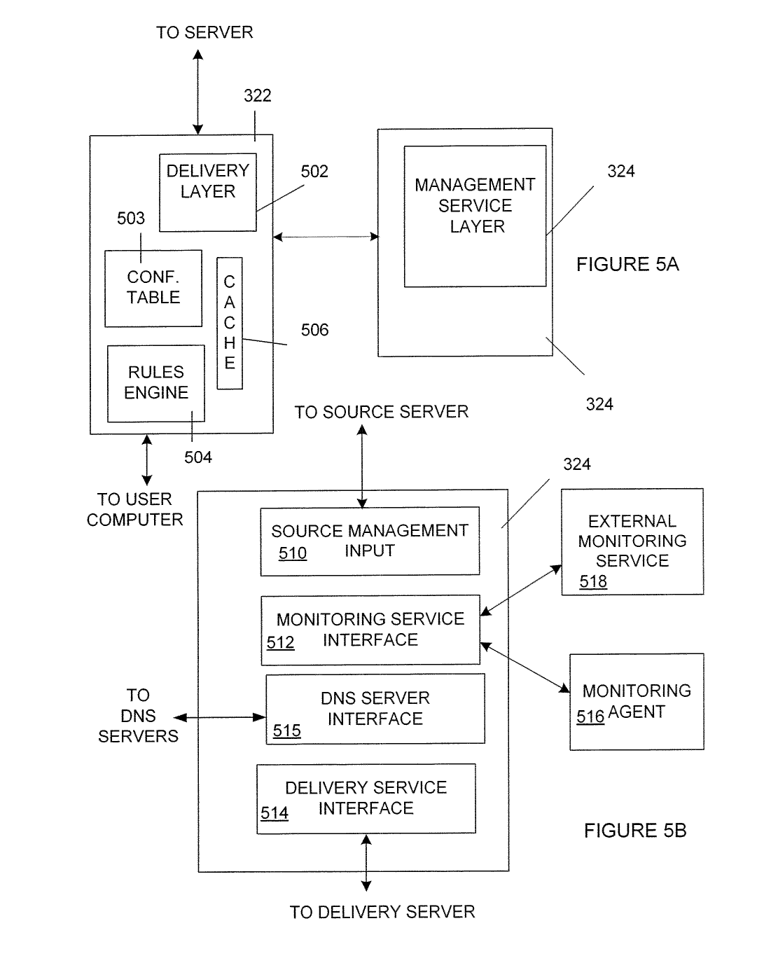

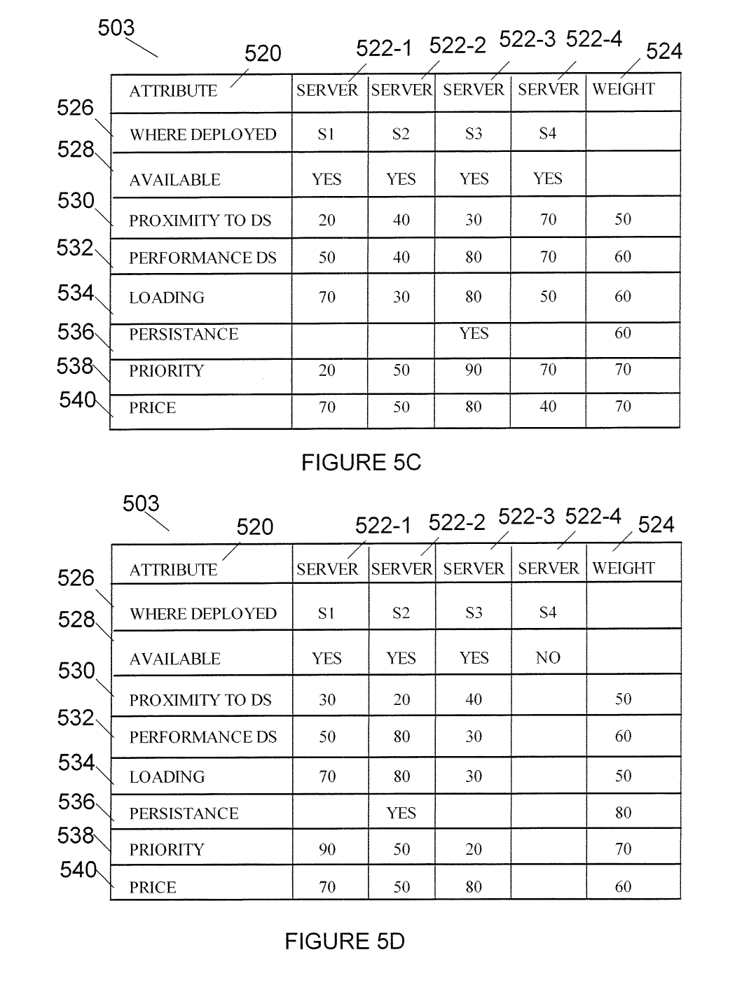

FIGS. 5A and 5B is used to describe the interaction between the user cloud, source cloud, mirror cloud, delivery server and the management server.

Referring to FIG. 5A, the delivery server 322 is configured to communicate with the management server 4. In one embodiment, the management server 324 communicates with the delivery server over the internet 302. The management server 324 communicates configuration information to the delivery layer. The configuration information is stored in the delivery server in a configuration table 503. Exemplary configuration information stored in the configuration table 503 will be further described with reference to FIG. 5C.

The delivery server 322 executes a delivery layer 502 program that decodes the user request and determines which of the available servers the user request is to be redirected. The delivery layer 502 uses the configuration information in the configuration table 503 to determine which of the available servers the user request is to be redirected. The delivery layer 502 uses a rules engine 504 to evaluate various attributes of the available servers to service the user request, stored in the configuration table 503. Based on this evaluation, the delivery layer 502 selects one of the available servers to forward the user request. The selection of a server by the delivery server 322 will be later described in detail.

The selected server receives the request over the internet, processes the request and sends a response to the delivery server 322. The delivery server 322 receives the response from the server over the internet. The delivery server forwards the response to the user application that generated the request. In some embodiments, the delivery server 322 modifies the response as appropriate and forwards the modified response to the user application that generated the request.

In some embodiments, the delivery server 322 may store the response data received from the server in a cache 506. When a subsequent request is received from a user computer, for the same data, the delivery server 322 may respond back to the user computer using the previously stored response data from the server stored in the cache 506.

The management server 324 executes a management service layer 508 program. Now, referring to FIG. 5B, the management service layer 508 includes a source management input interface 510, monitoring service interface 512, a delivery service interface 514 and a DNS server interface 515.

The source management input interface 510 is configured to receive input regarding various attributes of the servers in the source cloud and mirror cloud. For example, in one embodiment, the source management input interface 510 may permit an administrator of the server resources to configure various attributes of the servers. Configuration of server attributes will be later described in detail with reference to FIGS. 5C and 5D.

The monitoring service interface 512 is configured to receive status of various mirror clouds and servers within the mirror clouds. In one embodiment, the monitoring service interface 512 is configured to receive status as to whether a server is operational or not. In yet another embodiment, the monitoring service interface 512 is configured to receive information related to how long it takes to receive a first byte from the server. In yet another embodiment, the monitoring service interface 512 is configured to receive information related to overall delivery time. This information may be indicative of how stable the network is. For example, one indicator may be fluctuation in bandwidth available for data transfer.

In one embodiment, the management server 324 may set up a plurality of monitoring agents 516 distributed and executed at various locations on the network to gather and provide information related to status of source cloud, various mirror clouds and servers within the source cloud and mirror clouds. In one embodiment, the information provided by the monitoring agents 516 may be raw data, which may be further processed by the management server 324 to evaluate the status of source cloud and various mirror clouds and servers within the source cloud and mirror clouds. In some embodiments, the monitoring agents 516 may additionally be distributed in some or all of the delivery servers 322.

In yet another embodiment, the management server 324 may be configured to receive the status of source cloud, various mirror clouds and servers within the source cloud and mirror clouds from monitoring agents configured by a third party. For example, the information may be received by the monitoring service interface 512 from an external monitoring service 518 that reports the status in a predefined format, for use by the management server 324.

The delivery service interface 514 of the management server 324 is configured to communicate with delivery servers 322. In one embodiment, the management server 324 configures the delivery serve using the delivery service interface 514. In some embodiments, the management server 324 may specifically set up attributes of the mirror clouds for use by the delivery server 322. These attributes may include availability of one or more mirror clouds to service a request, attributes of the one or more mirror clouds based on the information received from the monitoring service. In some embodiments, the management server 324 may feed information related to source cloud and various mirror clouds and the delivery server 322 determines the server to be used to service a user request.

In some embodiments, the delivery server 322 may communicate status of source cloud or one or more mirror clouds to the management server 504, based on the characteristics of the response received by the delivery server 322. The management server 324 may use this information to update or modify the delivery server 322 so that a reconfigured source cloud or a mirror cloud may be used by the delivery server 322 to service future requests. In some embodiments, information provided by the delivery service interface 514 is stored and updated in the configuration table 503 of the delivery server 322.

The DNS server interface 515 of the management server 324 is configured to communicate with various DNS name servers 323. In one embodiment, the management server 324 sets up various DNS name servers 323 so that a request from a user application is routed to a specific delivery server 322. In one embodiment, the DNS name servers 323 are set up so as to route a request from a user application to a closest delivery server 322.

Although in these examples, a management serve 24 is described as a separate unit, as one skilled in the art appreciates, the functionality of a management server may be implemented and executed in one or more of the delivery servers 322. For example, the functionality of a management server may be implemented as a program executable on a delivery server.

Now, referring to FIG. 5C, the setup and use of an exemplary configuration table 503 for application SA0 is further described. Configuration table 503 shows various attributes in column 520, corresponding data for each server in columns 522-1 to 522-4 and an exemplary weight for some of the attributes in column 524. Although configuration table 503 is described with columns and rows, as one skilled in the art appreciates, configuration table 503 may be implemented using various data structures with storage elements to store the values. Although some of the attribute values are shown as a number, other means of storing a value or a rank to indicate relative values of the attribute may be used.

Multiple separate tables may be constructed to implement storage, retrieval and modification of the attributes for each of the applications. For example, exemplary configuration table 503 shown in FIG. 5C may be the configuration table maintained in delivery server 322-1 for application SA0. As previously indicated, for convenience, in configuration table 503 server 304 is referred to as server S1. Similarly, servers 305, 314 and 316 are referred to as S2, S3 and S4 respectively.

Row 526 indicates where the application is deployed. For example, application SA0 is deployed on servers S1, S2, S3 and S4. In one embodiment, this information is received by the source management input 510 of the management server 324. For example, the administrator of application SA0 may send this information to the management server 324, either through an application or directly using an input device on the management server 324. And, the management server 324 communicates this information to the delivery server 322-1 using the delivery service interface 514. As one skilled in the art appreciates Row 526 may be periodically updated with any changes related to where the application SA0 is deployed.

Row 528 indicates whether the server is available to service request from the delivery service. In this example, the application SA0 deployed on servers S1, S2, S3 and S4 are available for receiving requests from the delivery server 322-1. As one skilled in the art appreciates, in some embodiments, available servers for a given application may be selectively configured to be different on different delivery servers. For example, in one embodiment, only servers S1, S2 and S3 may be available for application SA0 on delivery server 322-2, which will be described with reference to FIG. 5D.

Row 530 proximity to DS indicates proximity of a server to the delivery server. In this example, proximity of servers have a value, for example, between 1-99 with lower number preferred over a higher number. Based on the values for servers S1, S2, S3 and S4, ranked proximity of servers to delivery server 322-1 is S1, S3, S2 and S4. Proximity to DS may be measured using various characteristics.

For example, one of the characteristics is geo-proximity or geographic proximity of a server to the delivery server. This may be measured using attributes that indicate physical location of the delivery server and the server. IP address of the delivery server and the server may be an indication of the geo-proximity. In one embodiment, the geo-proximity information is obtained by the delivery server from an external service. In one embodiment, information necessary to determine geo-proximity may be provided to the delivery server and the delivery server calculates the geo-proximity.

Another characteristics may be network proximity. This may be measured by delivery server sending a request to the server and receiving a response back from the server. For example, a ping command is sent by the delivery server to the server and time to receive the response is measured.

In some embodiments, a combination of geo-proximity and network proximity may be used to arrive at a combined value indicative of the proximity to delivery server. In the example, ranked proximity of servers to delivery server 322-1 are S1, S3, S2 and S4. i.e S1 is closest and S4 is farthest.

Next, row 532 indicates the performance of the servers as seen by the delivery server. In one embodiment, the delivery server may periodically measure the time it takes to get the first byte from the server and time it takes to get a quantity of data, for example, full record. Using one or more of these values, performance of the servers as seen by the delivery server may be calculated as a value from 1-99, with higher number indicative of better performance. In the example, ranked performance of servers as seen by delivery server 322-1 is S3, S4, S1 and S2.

Row 534 indicates the loading of various available servers. Loading of servers may be relative or absolute. For example, only 40% of the server capacity is allocated to service various requests and 60% of the allocated capacity is currently being used. In other words, 24% of the available 40% allocated capacity is currently being used. Allocated capacity may be set up by an administrator of a server or an application, using the source management input 510 layer of the management server 324.

In some embodiments, monitoring agents 516 may be able to measure and report actual capacity being used by the servers. This information may be communicated to the delivery server 322-1 from the management server 324. In the example, loading of servers is indicated as a value between 1-99, with a higher value indicative of a preferred server over a server with lower value. Based on these values, servers S3, S1, S4 and S2 are ranked as most preferred to least preferred server, under this example.

Row 536 indicates persistence or stickiness. For a given application, there may be a preference to send a request from a user application to a specific server hosting a specific application. This is indicated as persistence. As an example, for application SA0, for a specific user application, according to the configuration table 503, server S3 is the preferred server. In some embodiments, persistence indicates that the specified server has some information related to the user application that makes it preferable (or affinity) to send the request from the user application to that server. For example, the user has been previously authenticated by the server or the user may be currently logged in. In some embodiments, unique information related to the user may be hashed and based on the hash value, the request is sent to a specific server from amongst the available server. In this way, subsequent requests from the same user may be directed to the same server. In some embodiments, a link to the server may already be open and established, which may also be a factor in determining persistence.

Row 538 indicates priority or the preferred server to send the request, if a plurality of servers are available. As an example, priority 538 ranking may be used to select one of the two or more servers that are equally preferred. The priority 538 is indicated as a value between 1-99 with higher value indicative of a higher priority than a lower value. Based on the values for priority 538 for available servers, in this example, servers S3, S4, S1 and S2 are ranked as most preferred to least preferred. In one embodiment, an administrator sets the priority for the servers using the source management input 510 interface.

Row 540 indicates price or the cost of servicing a request from a given server. For example, some of the servers may be hosted servers from third parties that are available for a fee. In some embodiments, the link to the host may have a differential pricing based on the time of day. In one embodiment, the price 540 attribute has a numerical value between 1-99, with higher value indicative of a more preferred pricing than a lower value number based on the cost of servicing a request. In this example, based on the price 540, servers S3, S1, S2 and S4 are ranked as most preferred to least preferred respectively. In some embodiments, price 540 may be an absolute value for each of the server. In some embodiments, the price 540 may vary based on the time of day.

Row 524 indicates the weight to be given to some of the attributes. In one embodiment, this information is received by the source management input 510 of the management server 324. For example, the administrator of application SA0 may send this information to the management server 324, either through an application or directly using an input device on the management server 324. And, the management server 324 communicates this information to the delivery server 322-1 using the delivery service interface 514. Weight 524 may be set differently for each of the server application and each of the delivery servers.

Using values for various attributes in configuration table 503 for server application SA0 and the weight 524 for various attributes, the rules engine 504 selects one of the available servers to send the request. As an example, rules engine selects server S3 to service the request received by delivery server 322-1 for server application SA0.

FIG. 5D shows yet another configuration table 503 for application SA0, on delivery server 322-2. For example, referring to row 528, for delivery server 322-2, application SA0 is only available on servers S1, S2 and S3. Additionally some of the attributes have different values for application SA0 on delivery server 322-2. For example, the weight for loading 534 is different. As another example, the loading 534 is different for server S2 and Server S3. As previously discussed with reference to FIG. 5C, some of these attributes are either set differently for delivery server 322-2 or measured to be of different value for or by the delivery server 322-2.

So, for example, a request for service generated by a user application for server application SA0 from user computer P of user cloud 328 will be directed to delivery server 322-2. And, the available servers to service the request from user application of user computer P will be S1, S2 and S3, which is different than available servers to service request from user application of user computer X, as previously described with reference to FIG. 5C.

Using values for various attributes in configuration table 503 for server application SA0 and the weight 524 for various attributes, the rules engine 504 selects one of the available servers to send the request. As an example, rules engine selects server S2 to service the request received by delivery server 322-2 for server application SA0.

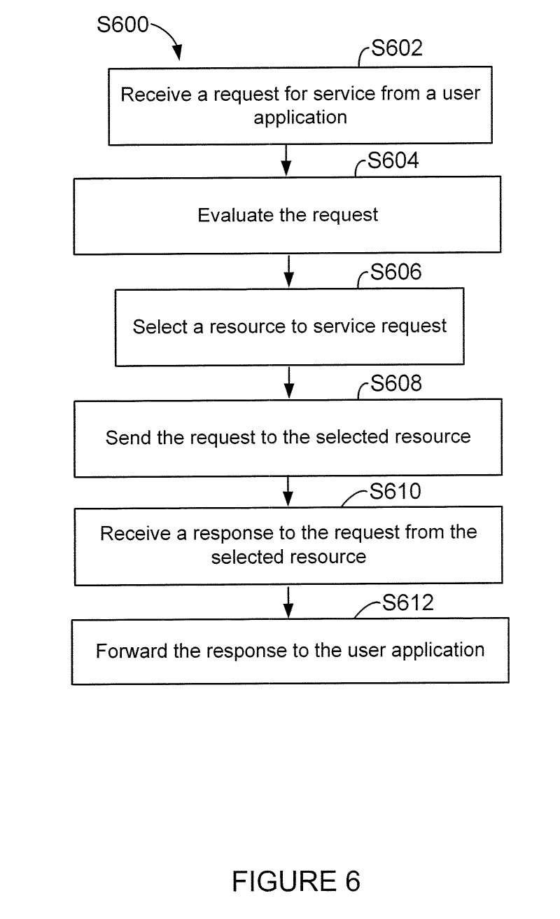

Now referring to FIG. 6, method to process a request S600 according to an exemplary embodiment of this disclosure is described.

In block S602, a request for service is received from a user application. For example, a request for service is generated by the user application executing on the computing system X. In one embodiment, the request for service may be a URL, based on the HTTP protocol. For example, the request for service may be directed to server 304 (also referred to as server S1) of source cloud 310. Based on the setup of the DNS name server, the request for service is routed to the preferred delivery server. For example, the delivery server 322-1 receives the request.

In block S604, the request is evaluated. The delivery server 322-1 evaluates the request and determines the request is for application SA0. Configuration table 503 stores various attributes for application SA0. As previously described, portion of the URL in the request indicates the server application the request is directed to.

In block S606, a resource is selected to forward the request. For example, the rules engine 504 of the delivery server 322-1 evaluates the information related to various attributes stored in configuration table 503 for application SA0 and selects one of the available servers to service the request for application SA0. In one embodiment, the request for service may be directed to server 304 (S1) of source cloud 310, the delivery server 322-1 may select another server to service the request. For example, the delivery server 322-1 selects web server 314 (S3) of mirror cloud 312 to service the request for application SA0.

In block S608, the request is sent to the selected resource. For example, the delivery server 322-1 sends the request to server 314 (S3). In some embodiments, the request is modified to indicate that the source of the request is the user application. In one embodiment, the header portion of the HTTP request is modified to indicate the source of the request. In some embodiments, one or more cookies may be added or deleted to the request.

In block S610, response to the request is received from the selected resource. For example, the request sent to web server 314 (S3) is processed by web server 314 and a response is sent to the delivery server 322-1.

In block S612, the received response is forwarded to the user application. As an example, the response received by delivery server 322-1 is forwarded to user application of user computer X that requested the service. In some embodiments, the received response may be modified. For example, one or more cookies may be added or deleted.

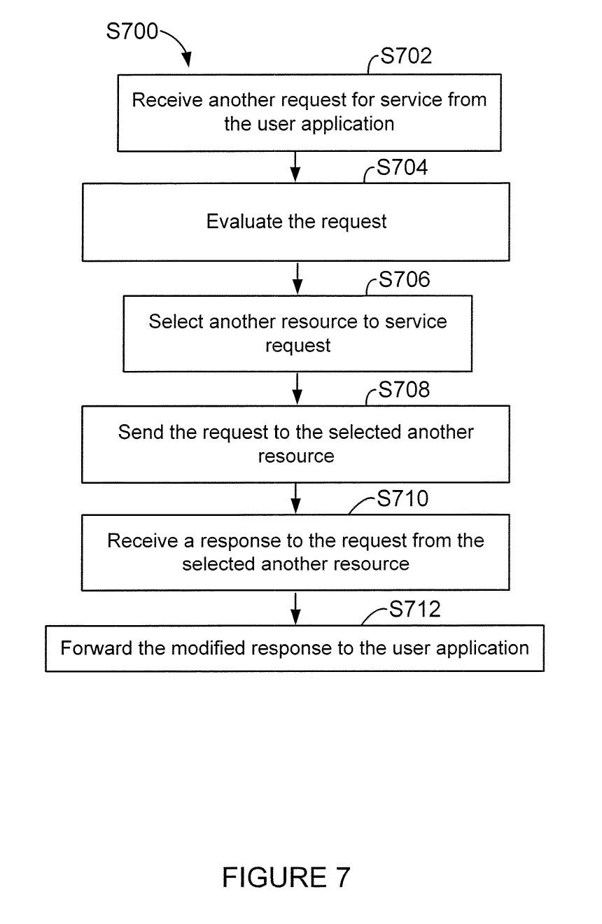

Now referring to FIG. 7, method to process another request S700 according to an exemplary embodiment of this disclosure is described.

In block S702, another request for service is received from a user application. For example, another request for service is generated by the user application executing on the computing system X. In one embodiment, the request for service may be a URL, based on the HTTP protocol. In one embodiment, the another request is directed to the same application as the previous request described with reference to FIG. 6. In one embodiment, the request for service may be directed to server 304 of source cloud 310 for service SA0. The another request for service is decoded and directed to delivery server 322-1.

In block S704, the request is evaluated. The delivery server 322-1 evaluates the another request and determines the request is for application SA0. Configuration table 503 stores various attributes for application SA0. As previously described, portion of the URL in the request indicates the server application the request is directed to.

In block S706, a resource is selected to forward the request. For example, the rules engine 504 of the delivery server 322-1 evaluates the information related to various attributes stored in configuration table 503 for application SA0 and selects one of the available servers to service the another request for application SA0. As some of the attributes stored in configuration table 503 might have changed, the delivery server 322-1 may select a different server to service the another request. For example, the delivery server 322-1 selects web server 304 (S1) of source cloud 310 to service the request. In one embodiment, selection of web server 304 may be based upon the evaluation of information in the configuration table 503 by the rules engine 504. For example the configuration table may indicate that web server 314 (S3) is no longer available and best server to service the request is web server 304 (S1). In some embodiments, web server 314 (S3) may still be available, but based on various attribute 520 values and weight 528, the rules engine 504 may select web server 304 (S1) instead of web server 314 (S3) that was selected to service earlier request.

In block S708, the request is modified and sent to the selected resource, the request is sent to the selected resource. For example, the delivery server 322-1 sends the request to server 304 (S1). In some embodiments, the request is modified to indicate that the source of the request is the user application. In one embodiment, the header portion of the HTTP request is modified to indicate the source of the request. In some embodiments, one or more cookies may be added or deleted to the request.

In block S710, response to the request is received from the selected another resource. For example, the request sent to web server 304 (S1) is processed by web server 304 and a response is sent to the delivery server 322-1.

In block S712, the received response is forwarded to the user application. As an example, the response received by delivery server is forwarded to user application of user computer X that requested the service. In some embodiments, the received response may be modified. For example, one or more cookies may be added or deleted.

As it is apparent to one skilled in the art, requests from user applications are processed and serviced using a plurality of sources, based on various attributes of the available sources. The redirecting of the user request happens transparently to the user application. Additionally, using the management server 324, the resources to service requests may be dynamically changed. Additionally, any changes to the attributes of the configuration table 503 are updated on a per delivery server basis. This may facilitate optimal use of available resources.

Although in this disclosure reference is made to a source cloud and a mirror cloud for convenience, the disclosure is not limited to the disclosed embodiments. In some embodiments, source cloud may refer to a primary set of resources available for an enterprise and one or more mirror clouds may refer to additional set of resources available to the enterprise. In some embodiments some of the mirror clouds may be additional resources available in a different geography. In some embodiments, some of the mirror clouds may be additional resources used by an enterprise, from an external service provider who provide computing resources on an as needed basis, for example, as an outsourced resource. In some embodiments, the available resources may be a combination of an enterprise resource and outsourced resource. In some embodiments, all of the servers may be hosted using third party resources, with no distinction between a source cloud and a mirror cloud.

Although the source cloud and mirror clouds have been described with one or more servers and databases, these clouds may be implemented with additional servers and databases that may act as redundant systems or cumulative systems. In some embodiments, pool of resources may not be grouped as source clouds and mirror clouds and instead, appear as multiple resources available to process a request. In some embodiments, database accessible to a server may be remote and the server may access the database over a wide area network.

As one skilled in the art appreciates, various embodiments of this disclosure may provide one or more of the following benefits. For example, number of servers to service a request may be selectively configured for each of the delivery servers. Dynamic load balancing between different servers may be performed based on measurements by monitoring agents, needs of the enterprise, costs of resources, time of day, amount of load on various servers and the like.

While embodiments of the present invention are described above with respect to what is currently considered its preferred embodiments, it is to be understood that the invention is not limited to that described above. To the contrary, the invention is intended to cover various modifications and equivalent arrangements within the spirit and scope of the appended claims.

What is claimed is:

1. A method for processing a request for service from a user application, comprising:
receiving the request for service from the user application, the request directed to a server application;
providing a plurality of servers to service the request;
selecting a server to service the request from amongst the plurality of servers;
sending the request to the selected server;
receiving a response from the selected server; and
forwarding the received response to the user application.

2. The method of claim 1, further including:
receiving another request for service from the user application, request for service directed to the same server application;
selecting another server to service the another request;
sending the another request to the selected another server;
receiving another response from the selected another server; and
forwarding the another response to the user application.

3. The method of claim 1, wherein the plurality of servers available to service the request are different for requests originating from user applications from different user computers.

4. The method of claim 1, wherein the received response is modified before forwarding to the user application.

5. The method of claim 1, wherein the step of selecting a server to service the request further including:
Identifying one or more servers available to service the request;
Evaluating one or more attributes of the available servers; and
Selecting one of the available servers to service the request.

6. The method of claim 5, wherein one or more attributes of the servers are periodically updated.

7. A system for processing a request from a user computer to a server application, comprising:
A delivery server configured to receive the request for service from the user application executed on the user computer, request for service directed to the server application;
select a server from amongst a plurality of servers to service the request;
send the request to the selected server;
receive a response from the selected server; and
forward the response to the user application.

8. The system of claim 7, wherein the delivery server is configured to
Receive another request for service from the user application, request for service directed to the same server application;
Select another resource to service the another request;
Modify the another request and send the another request to the selected another server;
Receive a response from the selected another server; and
forward the response to the user application.

9. The system of claim 7, wherein the delivery server
identifies one or more servers available to service the request;
Evaluates one or more attributes of the available servers; and
Selects one of the available servers to service the request.

10. The system of claim 9, wherein one or more attributes of the servers are periodically updated.

11. The system of claim 10, wherein the delivery server receives information relates to the servers from a management server and updates one or more attributes of the servers.

12. The system of claim 11, wherein the management server includes:
a source management input layer to receive updates related to servers;
a monitoring service interface to receive status of available servers; and
a delivery service interface to communicate the status of available servers to the delivery server.

13. The system of claim 12, wherein the monitoring service interface receives status of available servers from a plurality of monitoring agents.

14. The system of claim 12, wherein the monitoring service interface receives status of available servers from an external monitoring service.

15. The system of claim 12, wherein the management server is part of the delivery server.

16. A system for processing requests from at least two user computers to a server application, comprising:
a first delivery server configured to
receive the request for service from the user application executed on first user computer, request for service directed to the server application;
select a server from amongst a first set of plurality of servers to service the request;
send the request to the selected server;
receive a response from the selected server; and
forward the response to the user application of the first computer;
a second delivery server configured to
receive the request for service from the user application executed on second user computer, request for service directed to the server application;
select a server from amongst a second set of plurality of servers to service the request;
send the request to the selected server;
receive a response from the selected server; and
forward the response to the user application of the first computer,
wherein the first set of plurality of servers are different than the second set of plurality of computers.

17. The system of claim 16, wherein the
first delivery server
identifies one or more servers available to service the request from the first set of plurality of servers;
evaluates one or more attributes of the available servers from the first set of plurality of servers; and
Selects one of the available servers from the first set of plurality of servers to service the request; and
the second delivery server
identifies one or more servers available to service the request from the second set of plurality of servers;
evaluates one or more attributes of the available servers from the second set of plurality of servers; and
selects one of the available servers from the second set of plurality of servers to service the request.

18. The system of claim 17, wherein one or more attributes of the first set of servers and the second set of servers are periodically updated.

19. The system of claim 18, wherein the first delivery server and the second delivery server receives information relates to the first set of servers and the second set of servers from a management server and updates one or more attributes of the first set of servers and second set of servers.

20. The system of claim 18, wherein the management server includes:
a source management input layer to receive updates related to servers;
a monitoring service interface to receive status of available servers; and
a delivery service interface to communicate the status of available servers to the first delivery server and the second delivery server.
